(19) United States
(12) Patent Application Publication
(10) Pub. No.: US 2009/0076978 A1
(43) Pub. Date: Mar. 19, 2009

(54) Electronic trade information graphical user interface

(76) Inventor: Rony Dayan, Haifa (IL)

Correspondence Address: Pearl Cohen Zedek Latzer, LLP, 1500 Broadway, 12th Floor, New York, NY, 10036, US

(21) Appl. No.: 11/902,793

(22) Filed: Sep. 25, 2007

Related U.S. Application Data
(60) Provisional application No. 60/960,055, filed on Sep. 13, 2007.

(51) Int. Cl. G06Q 40/00

(52) U.S. Cl. 705/36 R

(57) ABSTRACT

A method for displaying trading information relating to a tradable item being traded electronically on an electronic exchange is disclosed. The method comprises receiving market data corresponding to the tradable item, displaying on a display screen a bar chart representing historical trading information of this tradable item. The bar chart is shown on a scale of time versus price, each bar corresponding to a time window of predetermined time period and indicating at least an opening price, a closing price, highest price and lowest price for that time window. An end bar on the bar chart represents a current time window, indicating the opening price for the current time window. The method further comprises dynamically indicating the lowest price in which a transaction was made in the current time window, highest price in which a transaction was made in the current time window, and price of latest transaction. The market depth information comprising bid and offer orders for different price levels is simultaneously dynamically displayed on a grid superimposed on a strip on the bar chart representing the current time window, with the end bar merged on that strip.

### FIELD OF THE INVENTION

The present invention relates to a graphical user interface (GUI) for presenting data in real-time as well as historical data regarding commodities (stocks and material goods) and other tradable items that are simultaneously traded in an electronic exchange (bourse). A GUI, in accordance with the present invention, offers more information and better presentation of that information relating to tradable items in electronic exchange.

### BACKGROUND OF THE INVENTION

Presently available graphical user interface (GUI) technology makes it possible for a stock exchange or commodity trader to obtain in real-time information regarding a financial instrument of choice.

The available information is divided into two different sets of data: 1) the depth of the market for a given financial instrument, 2) the historical behavior of the price during a pre selected length of time up to the very latest trade figures and technical analysis (the term defined later in the text) presented and based on the historical data. A graphical information display of each of the data sets is presented in a different region of the display screen. Available GUI technology hardly integrates in real time the available information into a coherent market-picture, needed vitally to many traders to allow them to evaluate the situation of the market prior to taking trading decisions.

Many stock and commodity traders rely on technical analysis indicators for their trade decisions. Technical analysis indicators are divided to: 1) mathematically calculated indicators—indicators created by calculation i.e. moving averages (MA), relative strength index (RSI), Bollinger bands, pivot points, directional movement index (DMI), accumulation distribution, Eliot waves, Fibonacci levels, moving average convergence divergence (MACD) and many other indicators, known to those skilled in the art. Calculated indicators may also include propriety indicators based on a formula created by the user. 2) Free hand drawn objects—this type of technical indicator refers to any kind of object is drawn by the user on the chart presented, or on another chart (i.e. other time frame of the same traded instrument) and is presented on the chart display. 3) Any other type of object being presented on the chart by the trader.

Given below is a patent and four patent applications that summarize the state of the art, as it is known to the applicant of the present invention:

In U.S. Pat. No. 6,766,304 (Kemp II et al.) a method and system is given for reducing the time it takes for a trader to place a trade when electronically trading on an exchange, thus increasing the likelihood that the trader will have orders filled at desirable prices and quantities. The “Mercury” display and trading method of the presented invention ensure fast and accurate execution of trades by displaying market depth on a vertical or horizontal plane, which fluctuates logically up or down, left or right across the plane as the market prices fluctuates.

In WO 2007/046987 (Mather T. el al.) a method for analyzing financial data related to a financial instrument traded on an electronic exchange is described, which includes serially receiving sets of price and volume data including a price corresponding to a best bid, best ask, or a trade, and a volume representing the volume of units of the financial instrument available at the best bid price or best ask price or executed at the trade price, and generating a data point including a best bid price, a best ask price, a high price, a low price, a bid trade volume, a bid large trade volume, an ask trade volume, and an ask large trade volume of the financial instrument in the discrete time period, and determining whether the inside market has moved based at least in part on a relationship between the most recently received price and one or more of the current best bid price, the current best ask price, the current high price, and the current low price.

In WO 2007/048040 (Mather T. et al.) a method is given for trading a financial instrument includes displaying a dynamic price scale containing a plurality of prices corresponding to orders for a financial instrument, dynamically shifting the prices in the price scale when the inside market changes, displaying a plurality of buy order entry cells aligned with prices in the dynamic price scale and a plurality of sell order entry cells aligned with prices in the dynamic price scale, displaying a static inside market window around prices associated with the inside market, wherein the static inside market window does not move in response to a change in the inside market, and enabling a user to enter a buy or sell order by selecting one of the plurality of buy order entry cells or one of the plurality of sell order cells.

In US 2007/0118452 (Timothy S. et al.) a financial instrument trading interface with dynamic price scale is presented. The patent application describes a method for trading a financial instrument which includes displaying a dynamic price scale containing a plurality of prices corresponding to orders for a financial instrument dynamically shifting the prices in the price scale when the inside market changes, displaying a plurality of buy order entry cells aligned with prices in the dynamic price scale and a plurality of sell order entry cells aligned with prices in the dynamic price scale, displaying a static inside market window around prices associated with the inside market, wherein the static inside market window does not move in response to a change in the inside market, and enabling a user to enter a buy or sell order by selecting one of the plurality of buy order entry cells or one of the plurality of sell order entry cells.

In US 2007/0156565 (Singer et al.) a graphical interface and method are provided for displaying market information corresponding to a tradeable object. One graphical interface includes a chart region for displaying historical market data in relation to a first value axis, and a market graph region in alignment with the chart region. The market graph region comprises a plurality of areas for receiving commands from a user input device to send trade orders, and the areas are displayed in relation to a second value axis. A plurality of values displayed along the second value axis is a subset of values displayed in relation to the first value axis, and can be modified to a new plurality of values that corresponds to a new subset of values on the first value axis.

Presently, with existing GUIs, a trader can view the “depth of the market”, meaning that in addition to seeing the best bid and offer at a given time, he can also view what are the bids and offers at various price levels. A demonstration of viewing the depth of the market can be exemplified when orders in large amounts are presented at certain price levels, suggesting support and resistance levels for the market.

In the presently available GUI technology the market depth, the historical behavior and the technical analysis of a chosen commodity of interest are located next to each other. While in prior art the trading bar chart, technical analysis graphs and the market depth grid are only presented in close proximity one to the other the GUI technology, in accordance with the present invention, provides a trader with a real-time single screen display that integrates the three data-sets listed. The display shows market depth in a table combined with the market historical data bar charts and technical indicators, thus, giving the user a new perspective of multi dimensional information, improving and simplifying the ability to process information in real-time for obtaining efficient trading decisions.

### SUMMARY OF THE INVENTION

There is thus provided, in accordance with some preferred embodiments of the present invention, a method for displaying trading information relating to a tradable item being traded electronically on an electronic exchange. The method comprises receiving market data corresponding to the tradable item, displaying on a display screen a bar chart representing historical trading information of this tradable item. The bar chart is shown on a scale of time versus price, where each bar corresponds to a time window of predetermined time period and indicating at least an opening price, a closing price, highest price and lowest price for that time window. An end bar on the bar chart represents a current time window, indicating the opening price for the current time window. The method further comprises dynamically indicating the lowest price in which a transaction was made in the current time window, highest price in which a transaction was made in the current time window, and price of latest transaction, while simultaneously dynamically displaying market depth information comprising bid and offer orders for different price levels. The market depth is displayed on a grid superimposed on a strip on the bar chart representing the current time window, with the end bar merged on that strip.

Furthermore, in accordance with some preferred embodiments of the present invention, the method further comprises graphically displaying one or more technical indicators on the bar chart.

Furthermore, in accordance with some preferred embodiments of the present invention, said one or more technical indicators comprise one or more mathematically calculated technical indicators.

Furthermore, in accordance with some preferred embodiments of the present invention, said one or more technical indicators comprise one or more user-defined technical indicators.

Furthermore, in accordance with some preferred embodiments of the present invention, the method further comprises marking one or more cells on the grid relating to said one or more technical indicators.

Furthermore, in accordance with some preferred embodiments of the present invention, the method comprises marking one or more cells on the grid at which said one or more technical indicators intersect with the grid.

Furthermore, in accordance with some preferred embodiments of the present invention, said one or more technical indicators is derived from historical trading information from the displayed bar chart.

Furthermore, in accordance with some preferred embodiments of the present invention, the historical trading information relates to a period of time that is different than the period of time spanned by the bar chart.

Furthermore, in accordance with some preferred embodiments of the present invention, said one or more technical indicators is derived from historical trading information relating to time windows of a time period that is different from the time period pertaining to the time windows of the displayed bars.

Furthermore, in accordance with some preferred embodiments of the present invention, the method further comprises simultaneously displaying on the display screen additional trading information.

Furthermore, in accordance with some preferred embodiments of the present invention, the additional trading information is displayed on an area of the screen in which the bar chart is displayed.

Furthermore, in accordance with some preferred embodiments of the present invention, the additional trading information is displayed outside the area of the screen on which the bar chart is displayed.

Furthermore, in accordance with some preferred embodiments of the present invention, the method further comprises performing a transaction by moving a curser over an area of the screen on which the bar chart is displayed using an input device and inputting a command using the input device when the curser is over a location on the screen indicative of a desired price.

Furthermore, in accordance with some preferred embodiments of the present invention, the location indicative of the desired price is on the grid.

Furthermore, in accordance with some preferred embodiments of the present invention, the location indicative of the desired price is on the bar chart.

Furthermore, in accordance with some preferred embodiments of the present invention, the location indicative of the desired price is on one or more graphically displayed technical indicators.

Furthermore, in accordance with some preferred embodiments of the present invention, the method further comprises inputting orders by inputting commands into at least one of a plurality of bid/ask input cells which are displayed on an area of the screen on which the bar chart is displayed using an input device.

Furthermore, in accordance with some preferred embodiments of the present invention, the method further comprises inputting orders by inputting commands into at least one of a plurality of bid/ask input cells which are displayed outside the area on which the bar chart is displayed using an input device.

Furthermore, in accordance with some preferred embodiments of the present invention, the method further comprises performing transactions by clicking at least one of a plurality of bid/ask market order cells of the grid.

Furthermore, in accordance with some preferred embodiments of the present invention, the method further comprises inputting a trading strategy set of orders comprising one or more orders to buy or sell, and corresponding types of orders, which are stop-loss and take profit orders in case said one ore more orders are executed.

Furthermore, in accordance with some preferred embodiments of the present invention, the trading strategy relates to one or more graphically displayed technical indicators.

Furthermore, in accordance with some preferred embodiments of the present invention, the trading strategy set of orders is created by defining buy or sell direction and a transaction size and then indicating transaction parameters with a curser, which activated by an input device, related technical indicators from said one or more graphically displayed technical indicators.

Furthermore, in accordance with some preferred embodiments of the present invention, the indicated transaction parameters are selected by a user, the first parameter being a generator for a position opening, and the rest of the indicated transaction parameters being selected without indicating the type of the order.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a prior art GUI device, described in US 2007/0156565, displaying separately market depth display next to a history trade-chart.

FIG. 2 illustrates a prior art GUI device, described in US 2007/0118452, displaying separately market depth display and a history trade-chart, both displays given on a joint relative price scale.

FIG. 3 illustrates a GUI device, in accordance with the present invention, displaying a history bar chart, technical indicator graphs and an orders book grid including depth of the market all given on a joint relative price scale and interactive with each other in real time, all in an area of the screen in which the bar chart is displayed.

FIG. 4 illustrates a GUI device identical to the GUI presented in FIG. 3 except having the orders columns for installing amounts of bids or offers (ask) included in a separated grid outside the chart frame.

FIG. 5 illustrates another embodiment of a GUI device, in accordance with the present invention, a history bar chart, technical indicator graphs and an orders book grid including depth of the market, all given on a joint relative price scale and interactive with each other in real time, all in an area of the screen in which the bar chart is displayed and having in addition, in the display screen, tools that enable easy and direct trading transaction activities.

### DETAILED DESCRIPTION OF PREFERRED EMBODIMENTS

A GUI device, as defined in this document, is a graphical user interface for presenting data in real-time as well as historical data regarding stocks or commodities being traded in a market exchange.

Improving on the present available GUI technologies the GUI device, in accordance with present invention, provides an integrated, real-time, screen-view of the available market information shown in an interactive table inside the historical market information bar charts, thus, improving and simplifying the ability to rapidly process information for obtaining efficient and knowledgeable trading decisions.

The GUI device, in accordance with the present invention, provides graphical display bars indicating relevant historical market data such as highest bid and ask prices, the volume of trade transactions and opening and closing prices of trades which took place. Data of the last presented display bar is associated with a display grid merged with the bar graph. Also included in the graphical display are technical indicators in accordance to the choice of the GUI operator. The GUI device, in accordance with the present invention, generates an interactive table (grid) that includes the real-time available market figures: currently offered selling and buying prices (indicating “depth of the market”) and the prices in which transactions were carried out.

The GUI device, in accordance with the present invention, enables a stocks or commodities trader to determine the time frame intervals (time windows) for which he (or she) is interested in market history information, for instance every five minutes or every fifteen minutes.

In a single, quick glance, the user of the GUI device is given “the dimensions” of trade in a given stock or commodity: the historical “picture” of the market, relevant technical indicators information of choice as well as the instantaneous depth of the market, all these dimensions are combined and communicate with each other, allowing the user to make rapid knowledgeable decisions.

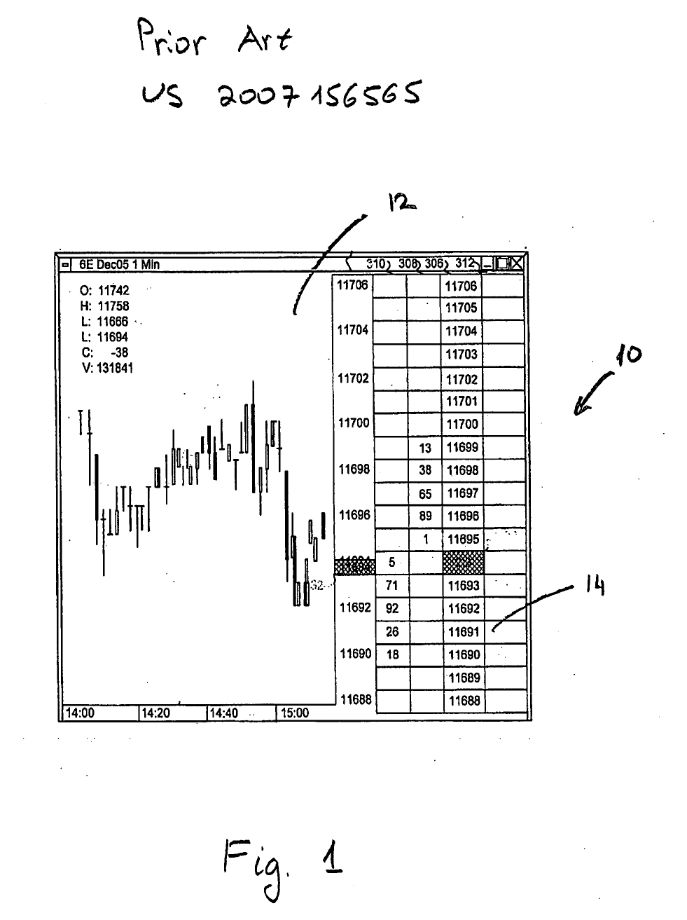

FIG. 1 illustrates a prior art GUI device 10 by the TT Company which displays two reigns, reign 12 being an historical chart and region 14 being a current prices orders book, including depth of the market. While GUI 10 presents at the same time the two data sets, the information is not given in a manner that will be useful to a trader working in a stressful trading environment that must take disicions in exteremly short time intervals. In the course of trading there is great importance to integrate the current market depth picture with the graphical shape of the historical market (graph) picture and how it relates to the technical indicators and graphical objects. In GUI 10 the current market depth dimension is completely visually and physically separated from the historical graph dimension. It is emphasized that the use of two separate reigns in GUI 10 makes the use of the derived information cumbersome.

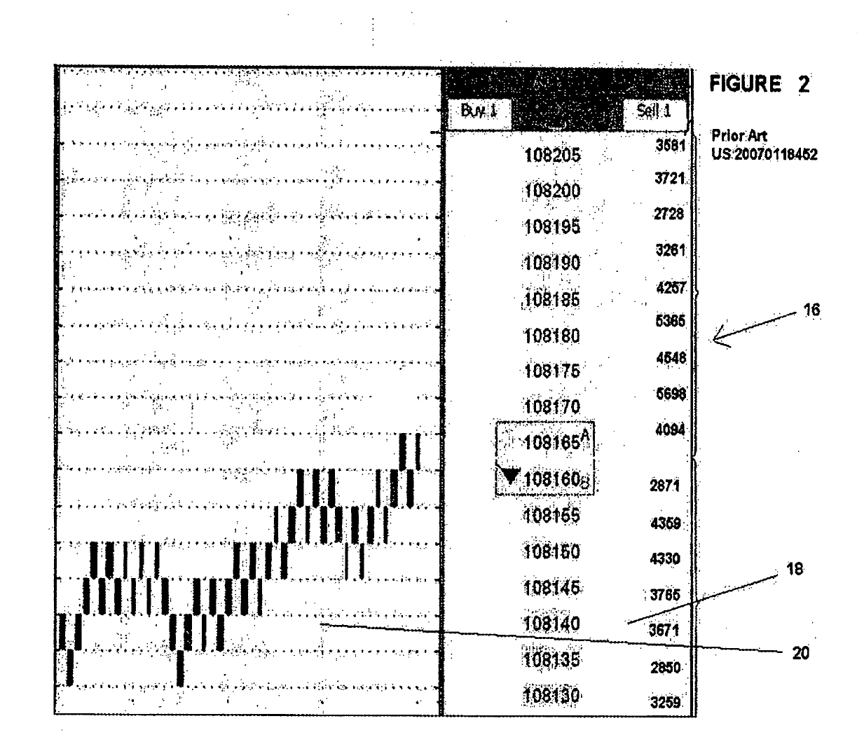

FIG. 2 illustrates another prior art GUI 16, developed by the CQG Company, which, similar to GUI 10 shown in FIG. 1, presents a graphical market history graph 20 in one region and a current orders book, including the depth of the market 18, in a second region. The same shortcomings mentioned in regards to GUI 10 are true for GUI 16.

A trader that uses graphical technical indicator tools such as moving averages, free hand-drawn lines and other graphical-objects for his decision making has to simultaneously integrate the information from indicators with the data-sets of the market numerical depth grid and the historical (graphic) data chart of historical behavior of the price including the current price behavior. Especially for day traders using graphical indicator tools the integration of the information must be done rapidly and many times during a trading session. The situation where the information of the two data-sets is displayed separately can be compared to watching a TV film with subtitles being presented outside the television screen. Moreover, to optimally operate in an intuitive trading process, a trader needs a clear, unified picture, with all the segments of the available data integrated. The advantage of an integrated trading picture utilized by a trader can be compared with a display within the helmet-display-screen of a modern fighter-pilot in combat in which all the data is presented and merges with the scenery encountered by the pilot during the flight.

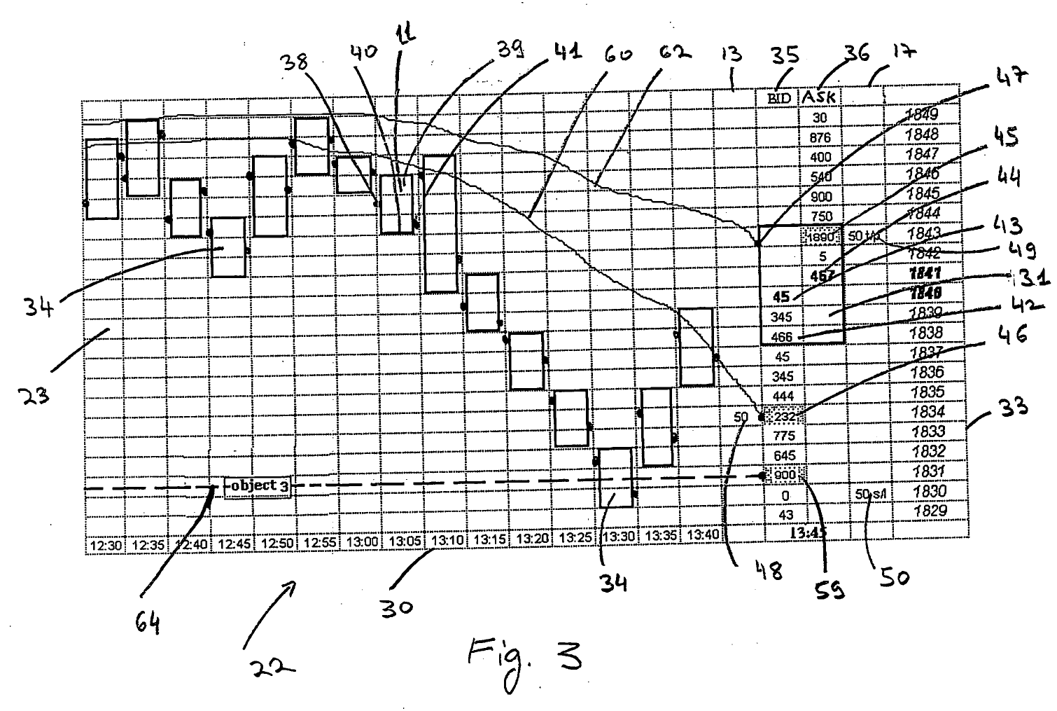

FIG. 3 illustrates a GUI device 22 (also referred to as “Gideon Sword”), in accordance with the present invention, displaying a graphical market history bars graph, technical indicator graphs 60, 62 and 64, and a current trade-bar 31 which intersects bid and ask data display coulombs (35 and 36, respectively), all given on a joint relative price scale and interactive with each other in real time.

In GUI device 22, in accordance with the present invention, as clarified in FIG. 3, the technical analysis of the trader communicates with the current market depth picture and enlightens the eyes of the trader with potential important connections between market depth picture and historical price behavior including analysis tools based on history. All the data is presented in a single visual picture, which merges all of the needed information for quick decision-making.

To illustrate the manner in which GUI device 22 operates and integrates data, a numerical example is given in FIG. 3. All the available information for the trader is presented within a single comprehensive frame (“an area of the screen in which the bar chart is displayed”), inside a historical chart 23 of the GUI device 22 (also referred to as “the financial instrument”). In the financial instrument the x-axis 30, represents the time scale, and the y-axis 33 represent the price scale. Inside the frame area of the historical chart 23 bar charts 34 are drawn where each bar represent a pre defined length of time. In the given example, each bar represents 5 minutes of trading activity. Once 5 minutes have elapsed, a new bar is created. Each bar contains at least the following information (for the demonstration see the bar between 13:00 and 13:05, indicated as No. 11): 1) The opening price, being marked as a left side small dot or line, indicated as 38 on the example bar, which is the price in which the first trade took place. 2) The highest price in which a trade took place during the time interval shown as the price level of the top of the bar, indicated as No. 39. 3) The lowest price in which a trade took place during the time interval, shown as the price level of the bottom of bar 40. 4) The closing price, being marked as a right side small dot or line, indicated as 41, which is the price in which the last trade took place during the time interval. The last bar on the right side is the current bar, designated as No. 31, which is a presentation of trading during the time interval that started at 13:45 up to current time. In the example the current real time while watching the chart is 13:48. Bar 31 shows that the first trade which took place during the time starting 13:45 was traded at a price level of 1839. The highest price a trade took place during 13:45-13:48 was 1843, and the lowest price a trade took place between 13:45-13:48 was 1838. In continuation of “current bar” 31, through the entire price range, are real-time bid and offer amounts, listed along columns 35 and 36, respectively, showing the orders book across the price range presented. The amounts show the total demand and supply at each price level, referred to as “the market depth”. For example, there is demand for 466 units of the commodity traded at a price of 1838, indicated as No. 42, meaning that the total number of orders in the market to buy the commodity at a price of 1838 reached a sum of 466 units. Viewing the depth of the market gives the trader very important information regarding what hides behind the best bid (indicated as No. 43), shown as 45 units at a price of 1840, and the best offer, 467 units at a price of 1841 (indicated as No. 44). In the example, if the trader cannot see the depth of the market, he cannot know that there is a large offer amount of 1890 units (indicated as No. 45) at a price of 1843. This information suggests that the market may have hard time to break the level of 1843 because many units are for sale at this price.

The depth of the market merge with the current bar in the market history bar chart, creating easy visual ability to understand the technical picture and the relation of these two dimensions of the market picture. In No. 31 we can see the current bar which started at 13:45, we can see the highest traded price and the lowest traded price during that time (3 minutes assuming current time is 13:48 as mentioned before) and we can also see the supply and demand in the light of last 3 minutes price behavior. Using GUI 22 it is possible to widen the observation window of the trade data and see the supply and demand of the different price levels in the light of what happened during the previous 78 minutes (or any time interval choice made by the trader). The possibility of merging the history with current orders book and market depth gives a readily displayed and clear wide perspective of the relation between current supply and demand with relation to what happened in the market history.

Shown in FIG. 3 is a display in GUI 22 of the margining (or superimposed) of information from technical analysis tools based on price history with current market events in terms of market depth. The linkage between the two data sets (referred to as “dimensions”) is presented in a graphical contact display. For example, indicated as No. 46, in which a trader chooses to present a moving average of 10 bars (MA 10), indicated as No. 60. The right end of the line points and touches on the relevant demand amount at the current indicator value. In other words, the current value of a moving average of 10 bars is 1834 and the MA 10 line lights the relevant demand cell, showing the trader that at this value there is a demand of 232 units. In another example, a trader presented moving average of 50 bars (MA 50), indicated as No. 62, and the right end of the line (indicated as No. 47) lights the relevant cell of supply (at cell designated No. 45) making it very easy and quick to see that there is a large supply of 1890 units at this point and act accordingly. In another example, in the historical chart 23 in the FIG. 3, a free-hand technical indicator line, 64 (referred to as “object 3”), is shown pointing to a price of 1830 at bid 900 units, seen as a lit cell (indicated as No.59).

Another embodiment of utilizing GUI device 22, in accordance with the present invention, is the ability to perform on-line trade transactions using the merged market data information displayed. Illustrated in FIG. 3, a trader can input bids (within the “my-bids” column,13) and offers (inside the “my-ask/offer” column,17). In an example, a trader installs a bid, an order to buy 50 units (indicated as No. 48) in “my-bid” column (indicated as No. 13) at a price of 1834. The trader also installs an offer, an order to sell 50 units (No. 49) in “my offers” column, indicated as No. 17, at a price of 1843 as a “take profit” order (t/p). These orders will be activated only if an open position becomes available. The trader also inputs a stop loss order (No. 50) to sell 50 units at a price of 1830 which will only be activated if the trader has an open long position. The trader can also click (using a mouse or keyboard order) on any of the cells in the columns of current market depth (No. 35 for the bids column and No. 36 for the ask column) and a trade will be executed. For example, if the trader clicks on No. 43, he immediately sells 45 units at a price of 1840.

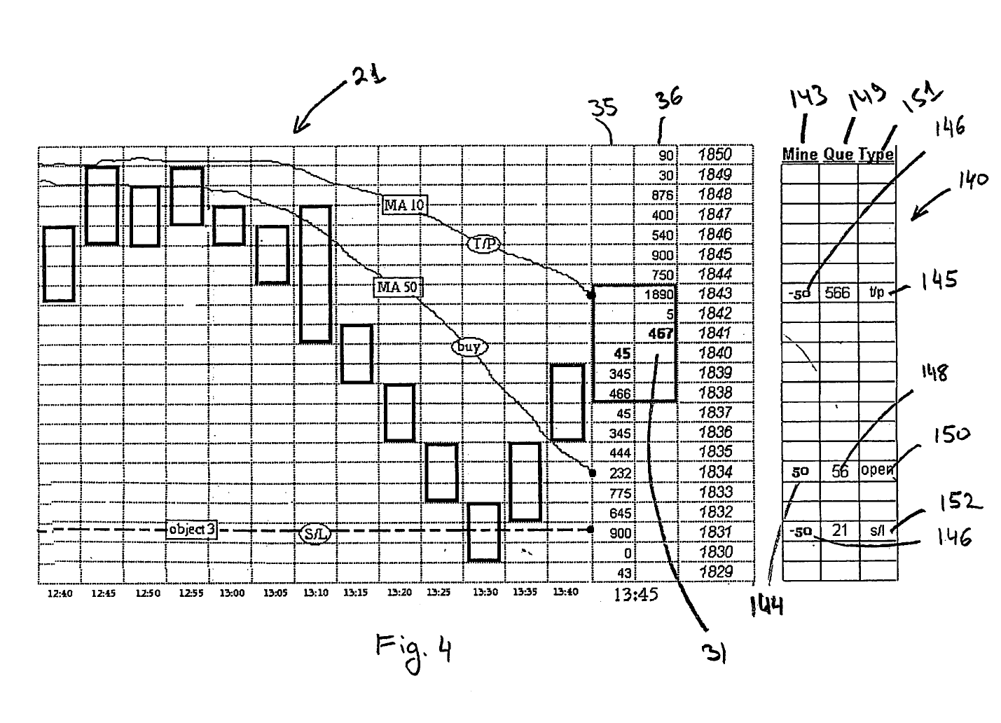

FIG. 4 illustrates a GUI device identical to GUI 22, referred to as GUI 21 presented in FIG. 3 except having the orders columns for installing amounts of bids or offers (ask) included in a separated grid 140 outside the chart frame. In this embodiment of the GUI device, in accordance with the present invention, order columns for installing amounts of bids or offers (ask) are not being shown inside the frame (columns 13 and 17, respectively, in FIG. 3) but in a separated grid outside the chart frame, referred to as the “execution and information grid” (No.140) comprising three columns: an amount column designated No. 143, specifying the amounts of stocks or commodities to be sold or purchased, a column, indicated as No. 149, giving the trading queue order, and a column, indicated as No. 151, giving the trader trade instructions and specifications. In the given example, the trader installs amounts in column 143. If the trader seeks to purchase 50 units at a price of 1834, he installs the number “50” inside the relevant cell (No. 144) and press “enter”. If the trader wants to install an order to sell 50 units at a price of 1843 that will depend on the execution of the purchase of the 50 units at 1834 mentioned previously in the text, the trader installs “−50 sl” (No. 146). The minus sign tells the system the trader wants to sell at this given price, the letters s/l tells the system this is a stop loss type of order. The letters “tp” (cell No. 145 in column 151) tells the system this is a “take profit” order, meaning, a dependent order to exit the trade in a profit at this price level. The letters s/l (No. 152) indicate a stop loss value for the traded commodity. It should be noted that the trader has the option to customize the style of orders installments. He can for example decide that he needs to type only the letter “p” after the amount in order to tell the system this is a take profit order. The “execution and information grid” (No.140) is the location to input orders, show the current picture of the trader's orders, the status (take profit, stop loss, opening a position etc.), the number of order units that are in front of the trader in the queue to buy at this price (i.e. the trader installed an order to buy 50 units at a price of 1834 (No.144). At No. 148 the trader can see that he has a queue of 56 units that will be executed before his order in case the price reaches 1834. At No. 150 the trader can see that the type of this order is an opening of a new position. In this embodiment a trader has the choice to click (using a mouse or a keyboard) on any of the cells in the columns of current market depth within columns No. 35 and No. 36 and a trade will be executed, as explained and elaborated in FIG. 3.

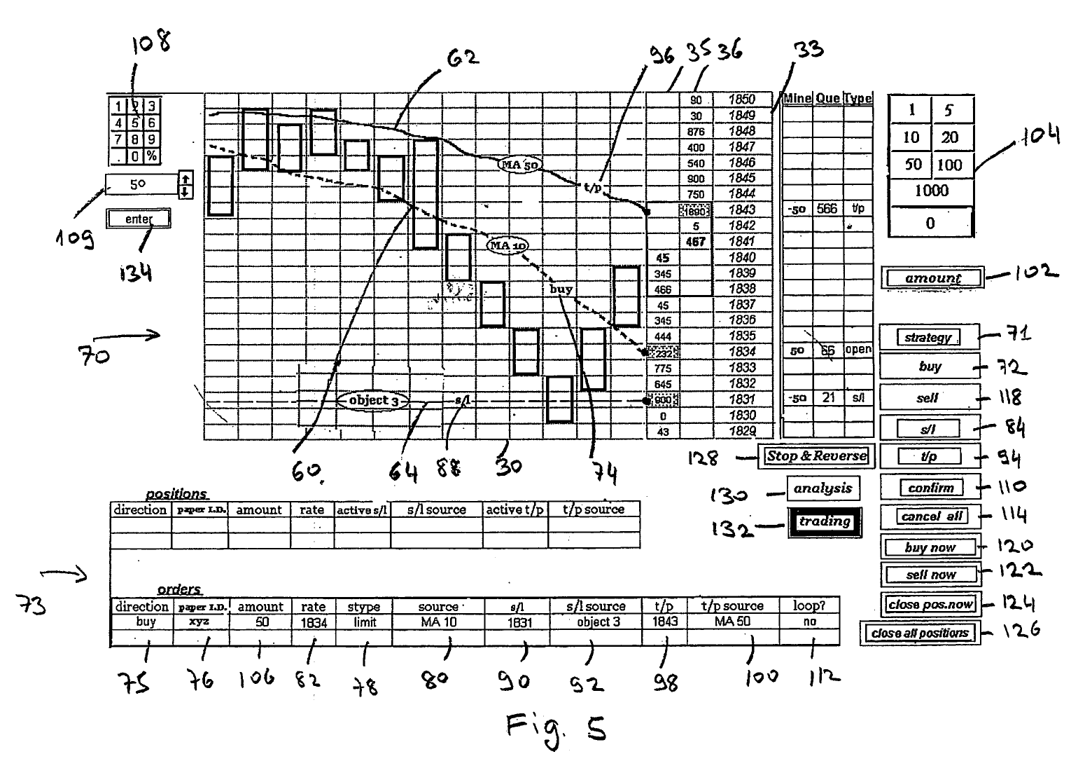

FIG. 5 illustrates another embodiment of a GUI device, designated No. 70, having similar characteristics as GUI 21 and GUI 22, in accordance with the present invention, displaying a history bar chart, technical indicator graphs and an orders book grid including depth of the market, all given on a joint relative price scale and interactive with each other in real time and having in addition to the display in FIG. 4, tools that enable easy and direct trading transaction activities. GUI device 70, which can serve as an active trading platform, includes a variety of buttons and tables, which are used to trade and build strategies. The platform enables the trader to build strategies based on technical tools being presented on the chart. An example for using GUI 70 is presented below. The given example in FIG. 5 is fully based on the time and price scales (30 and 33 respectively) as well as the various figures and graph presentations illustrated in FIG. 3 and FIG. 4.

A trader is interested in sending a set of orders for the following strategy: He wants to buy 50 units of stock XYZ if the price reaches the level equal to the level of MA10 (moving average of the last 10 bars), indicted as No. 60. If this order meets this condition and the order turns into an open position (in which case the user is LONG 50 units of stock XYZ), the user wants to insert a stop loss (s/l) if the price graph touches a free-hand technical indicator line 64 and the user also wishes to set a take profit (t/p) order if and when the price reaches the level of MA50 (moving average of the last 50 bars), indicated as No. 62. The s/I and the t/p are active only if an open position is on.

To peruse the strategy the trader performs the following steps: 1) The user clicks on button 71 (the “strategy button”). The system now waits for instructions regarding a strategy the user is interested to act by. 2) The user clicks on button 72 (the “buy button”) and proceeds to touch the MA10 curve (No. 60) presented in the graph. The curve becomes colored indicating it turned “active”. A small icon is set on, or near, the curve with the word “buy” (No.74). The user has entered an order to buy the XYZ stocks if and when the price will intersect with the MA 10 value. As a result of the touch on the MA10 curve, in the recording table of the transaction activities 73 the field of the direction of the requested order (indicated as No. 75) is filled with the word “buy”, the field of the “paper I.D” in the table (No. 76) is filled with XYZ, the field of “Stype” (No. 78) is filled with “limit” meaning limit, and the field “source” (No. 80) which shows the object/indicator which produced the order is filled with “MA10” which meaning that the trigger for the order is the 10 days moving average 60. Field No. 82 of table 73, fills with the current value of MA10 (in this case, 1834) 3). Now, the user clicks on button “s/l” (No.84) in order to set a stop loss. The click on button No. 84 activates the cursor and the next object/indicator to be touched will be the source of the stop loss order. The user touches the free-hand indicator line 64, which becomes colored, indicating it turned “active”. A small icon is set in or beside the line with the word “s/l” (No.88). The field “s/l” (No. 90) in table 73 fills with the price-figure, which is the graphical position of line 64 vertically above current time (see FIG. 3), at 1831. In this case, line 64 is completely parallel to the time axis 30 (again, see FIG. 3), thus, the value is fixed during the time span of the axis. Field No. 92 (s/I source) in table 73 fills with the s/l source, which is “object 3” (being line 64). In the screen of GUI 70 the user has a visual picture on the graph and tables and sees were he buys and where he leaves the open position with a s/I order. He also sees in table the advance of his strategy build up and the exact details of the strategy. 4.) If now the user wants to set a “take profit” order as well and add it into the strategy he clicks on the button “t/p”, indicated as No. 94. The cursor activates again, ready to pick an object/indicator to become the source for the t/p order. The user touches “MA 50” line (No.62). The curve becomes colored, indicating it turned “active”, and a small icon is set in or beside the curve with the word “t/p” (No. 96). The field No. 98 in table 73 (“t/p”) fills with the price-figure, which is on MA 50 vertically above current time, at 1843. Field No. 100 in table 73 (“t/p source”) fills with the t/p source which is “MA 50”. Now the user has a visual view on the graph and sees were he buys, where he leaves from the potentially open position with a s/I order and where he takes his profit. He also sees in table 73 his strategy's build up and the exact details of the strategy. All these were achieved without a usage of any logical expression in a complete visual and intuitive way. 5.) The last step is to insert the amount of the trade. The user clicks on button “amount” (No. 102) and chooses the amount in the pre set choices of different amounts, designated 104. In the example the user chooses an amount of 50 units for the strategy. He does so by clicking on button “50” in table 104. The amount is shown in the amount section 106 in the table 73. Another option to choose an amount is to put the cursor in calculator-field, designated No. 108 (having a display widow No. 109). The user clicks the chosen amount using numbers in the frame field. 6.) The strategy is now set and ready to be sent to the broker/market maker. In order to send the order the “confirm button” 110 has to be clicked. On clicking the whole table of the strategy 73 blinks until it is confirmed by the broker/market maker server. When confirmed the blinking stops and the table becomes green. The user knows his strategy is working and “is alive” out in the market. If the user accidentally chose MA 50 (No. 62) as a “stop loss”, the system will not accept the order, warning him his order is not logical (because a stop loss cannot be at a higher price comparing to the original “buy” price. And the same goes with “take profit” order. GUI device 70 in FIG. 5 includes operating buttons which further assist in the rapid execution of trade transactions. These buttons include: a “cancel all” button (No. 114) for stopping and restarting trading. A “sell” button (No. 118) which complements the “buy” command button (No. 118) that was previously mentioned and “buy now” (No. 120) and “sell now” (No. 122) for immediate trading transactions. Included are also buttons “close positions now” (No. 124) and “close all positions” (No. 126) for fixing market trade positions. Also included is a button for “stop and reverse” (No. 128) and buttons for “analysis” (No. 130) and “trading” (No. 132) that enable the choice of mode of operating the GUI, either in a trading mode or data analysis mode. An “enter” button for data logging 134 is placed on the upper left side of the screen. A repeated, “loop” command, transaction procedure, if desired, can be entered to in table 73 in space designated 112.

An even quicker way to send a strategy involves a “Turbo Process” in the following way. 1) The user clicks the button “strategy” (No.71). 2) The user clicks the button “buy” (No.72). 3) The user touches “MA 10” (No. 60) curve with the cursor. A “buy” icon 74 is presented on the curve. 4) The user touches free-hand line 64 with the cursor. A “s/l” icon is presented on the line, No. 88. (the system understands this is a s/l without the need to specifically define it, since this is a price lower then the potential buying price). 5) The user touches “MA 50” (No. 62) with the cursor. A “t/p” icon is presented on the line, indicated as 96. (the system understands this is a “take profit” order without the need to specifically define it, since this is a price higher then the potential buying price). 6) The user clicks the amount “50” (in table No.104). 7) The user clicks “confirm” (No. 110). This method is faster, and does not require defining which graphical object should perform as a “stop loss” source, and which graphical object should perform as a “take profit” source. The system figures this out by itself. The whole strategy is built in just 7 clicks, and with almost no need for thinking or concentration, almost free of the risk for logical errors. The whole process takes few seconds and the strategy is sent. It is completely visual-based, both on the graph and on the table you can see the progress and the details of the strategy being created. There is no need for a keyboard even though it is possible to use a keyboard on this system.

Unlike prior art GUIs, in the GUI device, in according with the present invention, the user sends orders with logical conditions without the need to define the conditions. The user does not have to describe the logic of the strategy to the trading system, meaning, the user does not have to use expressions like “greater then >” or “smaller then <” and therefore is free from the risk of making an error and choosing “greater then >” when he actually meant “smaller then<”, a common error in fast trading. The user does not use any input windows. The user trades using the objects on the chart in a real intuitive and visual based way. He does not have to bother himself with the logic behind his visual based intuitive idea. He looks at the objects, touching them with the needed buttons (buy, sell, s/l, t/p) and in few seconds, he sends the whole strategy. He does not need to concentrate in order to define logical expressions, and this process reduces dramatically the chance for an error (defining>instead of <) and enable turbo fast strategies sending method For day trader this is crucial. Moreover, for many people this is the only way to send strategies based on their intuitive ideas, since prior art systems involve logical definitions, a procedure that stand as a boundary to their abilities. The user sends all the parts (orders) of the strategy in one package unit. This dramatically reduces a potential confusion and minimizes the chance for errors.

It should be noted that the description of strategy building using technical the technique described for GUI 70 is also applicable for GUI 22 and GUI 21.

The GUI in accordance with the present invention provides traders with a powerful tool to see available opportunities. It enables to view analysis that combine the depth of the market with the technical indicators of charts and is based on historic performance information of a commodity of interest. It is practically impossible with the available GUIs to perform the analysis provided by the GUI in accordance with the present invention. The provided analysis is especially important for day traders that are required to make decisions in seconds and perform at times hundreds of transactions a day.

1. A method for displaying trading information relating to a tradable item being traded electronically on an electronic exchange, the method comprising:
receiving market data corresponding to the tradable item;
displaying on a display screen a bar chart representing historical trading information of the tradable item, the bar chart shown on a scale of time versus price, each bar corresponding to a time window of a predetermined time period and indicating at least an opening price, a closing price, highest price and lowest price for that time window,
wherein the bar chart further includes an end bar indicating a current time window representing the opening price for the current time window, and dynamically indicating the lowest price in which a transaction was made in the current time window, highest price in which a transaction was made in the current time window, and price of latest transaction; and
simultaneously dynamically displaying market depth information comprising bid and offer orders for different price levels on a grid superimposed on a strip on the bar chart representing the current time window, with the end bar merged on the strip.

2. The method as claimed in claim 1, further comprising graphically displaying one or more technical indicators on the bar chart.

3. The method as claimed in claim 2, wherein said one or more technical indicators comprise one or more mathematically calculated technical indicators.

4. The method as claimed in claim 2, wherein said one or more technical indicators comprise one or more user-defined technical indicators.

5. The method as claimed in claim 2, further comprising marking one or more cells on the grid relating to said one or more technical indicators.

6. The method as claimed in claim 5, comprising marking one or more cells on the grid at which said one or more technical indicators intersect with the grid.

7. The method as claimed in claim 2, wherein said one or more technical indicators is derived from historical trading information from the displayed bar chart.

8. The method as claimed in claim 7, wherein the historical trading information relates to a period of time that is different than the period of time spanned by the bar chart.

9. The method as claimed in claim 2, wherein said one or more technical indicators is derived from historical trading information relating to time windows of a time period that is different from the time period pertaining to the time windows of the displayed bars.

10. The method as claimed in claim 1, further comprising simultaneously displaying on the display screen additional trading information.

11. The method as claimed in claim 10, wherein the additional trading information is displayed on an area of the screen in which the bar chart is displayed.

12. The method as claimed in claim 10, wherein the additional trading information is displayed outside the area of the screen on which the bar chart is displayed.

13. The method as claimed in claim 1, further comprising performing a transaction by moving a curser over an area of the screen on which the bar chart is displayed using an input device and inputting a command using the input device when the curser is over a location on the screen indicative of a desired price.

14. The method as claimed in claim 13, wherein the location indicative of the desired price is on the grid.

15. The method as claimed in claim 13, wherein the location indicative of the desired price is on the bar chart.

16. The method as claimed in claim 13, wherein the location indicative of the desired price is on one or more graphically displayed technical indicators.

17. The method as claimed in claim 1, further comprising inputting orders by inputting commands into at least one of a plurality of bid/ask input cells which are displayed on an area of the screen on which the bar chart is displayed using an input device.

18. The method as claimed in claim 1, further comprising inputting orders by inputting commands into at least one of a plurality of bid/ask input cells which are displayed outside the area on which the bar chart is displayed using an input device.

19. The method as claimed in claim 1, further comprising performing transactions by clicking at least one of a plurality of bid/ask market order cells of the grid.

20. The method as claimed in claim 1, further comprising inputting a trading strategy set of orders comprising one or more orders to buy or sell, and corresponding types of orders, which are stop-loss and take profit orders in case said one ore more orders are executed.

21. The method as claimed in claim 20, wherein the trading strategy relates to one or more graphically displayed technical indicators.

22. The method as claimed in claim 21, wherein the trading strategy set of orders is created by defining buy or sell direction and a transaction size and then indicating transaction parameters with a curser, which activated by an input device, related technical indicators from said one or more graphically displayed technical indicators.

23. The method as claimed in claim 22, wherein the indicated transaction parameters are selected by a user, the first parameter being a generator for a position opening, and the rest of the indicated transaction parameters being selected without indicating the type of the order.
